(19) United States
(12) Patent Application Publication
(10) Pub. No.: US 2021/0333370 A1
(43) Pub. Date: Oct. 28, 2021

(54) LIGHT EMISSION METHOD, DEVICE, AND SCANNING SYSTEM

(71) Applicant: SZ DJI TECHNOLOGY CO., LTD., Shenzhen (CN)

(72) Inventors: Yue YAN, Shenzhen (CN); Shuai DONG, Shenzhen (CN); Chenghui LONG, Shenzhen (CN)

(21) Appl. No.: 17/372,023

(22) Filed: Jul. 9, 2021

Related U.S. Application Data
(63) Continuation of application No. PCT/CN2019/071024, filed on Jan. 9, 2019.

(51) Int. Cl. G01S 7/481; G01S 7/484; G01S 17/26

(52) U.S. Cl. CPC G01S 7/4817; G01S 17/26; G01S 7/484

(57) ABSTRACT

The present disclosure provides a light emission method. The method includes emitting a light pulse sequence; changing a propagation direction of the light pulse sequence to scan a surrounding environment; and controlling an emission frequency and/or emission power of the light pulse sequence based on a scanning speed of the light pulse sequence.

### CROSS-REFERENCE TO RELATED APPLICATIONS

This application is a continuation of International Application No. PCT/CN2019/071024, filed on Jan. 9, 2019, the entire content of which is incorporated herein by reference.

### TECHNICAL FIELD

The present disclosure relates to the technical field of optical pulse technology and, more specifically, to a method for controlling pulse frequency.

### BACKGROUND

Lidar is a sensing system that can obtain the spatial distance information in a direction of emission. The principle of lidar is to actively emit laser pulse signals to the environment, detect the reflected pulse signals, and determine the distance of the measure objects based on the time difference between the emission and the reception. The wavelength of the laser light source is in the sensitive spectral range of human eyes, and extended exposure of the light pulse signal of the laser to human eyes can cause damage to human eyes. As a result, improper scanning speed of the scanning system will cause the light pulse to stay in the human eyes too long, which will cause damage to human eyes or fail to obtain a higher scanning density.

### SUMMARY

One aspect of the present disclosure provides a light emission method. The method includes emitting a light pulse sequence; changing a propagation direction of the light pulse sequence to scan a surrounding environment; and controlling an emission frequency and/or emission power of the light pulse sequence based on a scanning speed of the light pulse sequence.

Another aspect of the present disclosure provides a light emission device. The light emission device includes a light pulse generating unit configured to emit a light pulse sequence; one or more optical elements configured to change a propagation direction of the light pulse sequence to scan a surrounding environment; and a control unit configured to control an emission frequency and/or emission power of the light pulse sequence based on a scanning speed of the light pulse sequence.

Another aspect of the present disclosure provides a distance measuring device. The distance measuring device includes a light emission device configured to emit light pulse sequences in sequence. The light emission device includes a light pulse generating unit configured to emit the light pulse sequences; one or more optical elements configured to change a propagation direction of the light pulse sequence to scan a surrounding environment; and a control unit configured to control an emission frequency and/or emission power of the light pulse sequence based on a scanning speed of the light pulse sequence; a receiving circuit configured to receive part of a light pulse signal reflected by an object from the light pulse sequence emitted by the light emission device, and convert the received light pulse signal into an electrical signal; a sampling circuit configured to sample the electrical signal from the receiving circuit to obtain a sampling result; and an arithmetic circuit configured to calculate a distance between the object and the distance measuring device based on the sampling result.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a light emission method according to an embodiment of the present disclosure.

FIG. 2 is a schematic structural block diagram of a distance measuring device according to an embodiment of the present disclosure.

FIG. 3 is a schematic diagram of the distance measuring device adopting a coaxial optical path according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The human eyes have different transmittance and absorption characteristics for different wavelengths of light radiation. Generally speaking, the transmission rate of the lens is higher in the 400-1400 nm band, which can damage the retinal of human eyes. The laser scanning system can generate visible or invisible high-intensity, high-directional light pulse sequences. When the wavelength is in the 400-1400 nm range, very low light pulse energy radiation can cause human eye damage.

In view of the above, an embodiment of the present disclosure provides a light emission method. FIG. 1 is a flowchart of a light emission method 100 according to an embodiment of the present disclosure. The method will be described in detail below.

S110, emitting a light pulse sequence.

S120, changing a propagation direction of the light pulse sequence to scan a surrounding environment.

S130, controlling an emission frequency and/or emission power of the light pulse sequence based on a scanning speed of the light pulse sequence.

In some embodiments, the scanning speed of the light pulse sequence can determine the duration of the light pulse in the human eye, and the emission frequency and/or the emission power of the light pulse sequence can determine the quantity of the laser pulses staying in the human eye. When the light pulse stays in the human for a short period of time, the emission frequency and/or emission power of the light pulse sequence can be increased within a reasonable range to obtain a higher scanning point cloud density and improve scanning accuracy. When the light pulse stays in the human eye for a long period of time, the emission frequency and/or emission power of the light pulse sequence can be reduced within a reasonable range to ensure the safety of the human eye.

In some embodiments, the method may further include detecting the scanning speed of the light pulse sequence, and changing the emission frequency and/or emission power of the light pulse sequence based on the change of the scanning speed of the light pulse sequence when the scanning speed of the light pulse sequence is within a predetermined range.

In some embodiments, when detecting that the scanning speed of the light pulse sequence is within the predetermined range, the scanning process may be normal. In this case, the emission frequency and/or emission power of the light pulse sequence can be adjusted based on the changes in the scanning speed of the light pulse sequence to take into account the safety of the human eye and the density of the scanned power cloud. When the scanning speed of the light pulse sequence becomes faster, the staying time of the laser in the human eye becomes shorter, and the emission frequency and/or emission power of the light pulse sequence can be increased within a certain range to increase the point cloud density under the premise of ensuring the safety of the human eye. When the scanning speed of the light pulse sequence becomes slower, the staying time of the laser in the human eye becomes longer. At this time, the emission frequency and/or emission power of the light pulse sequence can be reduced within a certain range to ensure safety of the human eye.

It should be noted that the range of change of the emission frequency and/or the emission power of the light pulse sequence may be different based on different scanning systems.

Based on the change of the scanning speed of the light pulse sequence, the change of the emission frequency and/or emission power can be linear or non-linear, such as stepwise change or exponential change, etc.

In some embodiments, changing the emission frequency and/or emission power of the light pulse sequence may include controlling the emission frequency and/or emission power of the light pulse sequence at a first time to be less than the emission frequency and/or emission power at a second time, the scanning speed of the light pulse sequence at the first time being lower than the scanning speed at the second time.

In some embodiments, changing the emission frequency and/or emission power of the light pulse sequence may include increasing the frequency and/or power of the laser pulse emitted by the radar when the scanning speed of the light pulse sequence increases; and/or, reducing the frequency and/or power of the laser pulse emitted by the radar when the scanning speed of the light pulse sequence decreases.

In some embodiments, the emission frequency and/or emission power of the light pulse sequence may change stepwise with the scanning speed of the light pulse sequence. Since the scanning speed of the light pulse sequence may be within a certain range, the time that the light pulse stays in the human eye may not change too much, therefore, the scanning speed of the light pulse sequence can be divided into multiple stages. The emission frequency and/or emission power of the corresponding light pulse sequence between each stage may be different, and the emission frequency and/or emission power of the corresponding light pulse sequence within each stage may be the same. In this way, the control difficulty can be reduced, the stability can be improved, and the frequent changes of the emission frequency and/or emission power of the light pulse sequence can be avoided, which affects the stability of the scanning.

In some embodiments, controlling the emission frequency and/or emission power of the light pulse sequence may include controlling the emission frequency and/or emission power of the light pulse sequence to a first emission frequency and/or first emission power when the scanning speed of the light pulse sequence is within a first range; and controlling the emission frequency and/or emission power of the light pulse sequence to a second emission frequency and/or second emission power when the scanning speed of the light pulse sequence is within a second range. In some embodiments, the value in the first range may be greater than the value in the second range, and the first emission frequency and/or first emission power may be greater than the second emission frequency and/or second emission power.

In some embodiments, the method may further include stopping emitting the light pulse sequence when the scanning speed of the light pulse sequence is lower than a predetermined minimal rotation speed.

In some embodiments, if the power component of the light pulse generating unit that drives the transmission of the light pulse sequence fails and the rotation speed of the power component is lower than a certain minimal threshold, reducing the emission frequency and/or emission power of the light pulse sequence may not meet the human eye safety requirements. At this time, the limiting factor for laser safety is the energy of a single pulse of the lidar, in order to protect the human eye, the strategy of stopping the laser from emitting light can be adopted.

It should be noted that the minimal threshold may be different for different scanning systems.

In some embodiments, changing the propagation direction of the light pulse sequence may include changing the propagation direction of the light pulse sequence by using one or more moving optical elements.

In some embodiments, changing the propagation direction of the light pulse sequence may include changing the propagation direction of the light pulse sequence by using one or more rotating light refraction element, the light refraction element including opposite, non-parallel light-emitting surfaces and light-incident surfaces.

In some embodiments, the one or more optical elements may include a lens, a mirror, a prism, an optical phased array, or any combination of the foregoing optical elements.

In some embodiments, the method may further include determining the scanning speed of the light pulse sequence based on the moving speed of the one or more moving optical elements.

Since the light pulse sequence is emitted after changing the propagation direction through the optical element, and the rotation of the optical element emits the light pulse sequence in various directions, the moving speed of the optical element may be positively correlated with the scanning speed of the light pulse sequence.

In some embodiments, the method may further include prompting the user when the scanning speed of the light pulse sequence is lower than a predetermined minimum rotation speed.

In some embodiments, when the scanning speed of the light pulse sequence is lower than the predetermined minimum speed, the scanning process may be abnormal, and the user can be prompted that the scanning process may be abnormal such that the user can troubleshoot in time.

In some embodiments, the method may further include receiving the light pulse signal reflected by the object; and determining the position of the object based on the received light pulse sequence.

In some embodiments, a light emission method may include emitting the light pulse sequence; changing the propagation direction of the light pulse sequence by passing the light pulse sequence through one or more optical elements to scan the surrounding environment; detecting the scanning speed of the light pulse sequence; and detecting the change in the scanning speed of the light pulse sequence if the scanning speed of the light pulse sequence is within a predetermined range.

In some embodiments, if the scanning speed of the light pulse sequence changes from the first range to the second range, and the speed of the first range is less than the speed of the second range, the emission frequency and/or emission power of the light pulse sequence may be controlled to increase from the first emission frequency and/or first emission power to the second emission frequency and/or second emission power. Since the speed in the first range is less than the speed in the second range, by increasing the scanning speed of the light pulse sequence, the time the light pulse stays in the human will decrease, and the human eye is relatively safe. At this time, the emission frequency and/or emission power of the light pulse sequence can be increased to obtain a larger point cloud density.

In some embodiments, when the scanning speed of the light pulse sequence is detected to be lower than the predetermined minimum speed, it may indicate that during the scanning process, the power component of the light pulse generating unit that drives the light pulse sequence is malfunctioning. At this time, the emission of the light pulse sequence can be stopped immediately to avoid causing eye damage due to low rotation speed.

An embodiment of the present disclosure provides a light emission device. The light emission device may include a light pulse generating unit configured to emit light pulse sequences, one or more optical elements configured to change the propagation direction of the light pulse sequence to scan the surrounding environment, and a control unit configured to control the emission frequency and/or emission power of the light pulse sequence based on the scanning speed of the light pulse sequence.

In some embodiments, the one or more optical elements may include one or more rotating light refraction element, the one or more light refraction element may include opposite, non-parallel light-emitting surfaces and light-incident surfaces.

In some embodiments, the control unit may be further configured to determine the scanning speed of the light pulse sequence based on the moving speed of the one or more moving optical elements.

In some embodiments, the light emission device may further include a detection unit configured to detect the moving speed of the one or more optical elements.

In some embodiments, the control unit may be further configured to determine whether the moving speed and rotation speed of the optical elements is within a predetermined range. If the moving speed of the optical elements is within the predetermined range, the change in the moving speed of the optical elements can be calculated, and the emission frequency and/or emission power of the light pulse sequence can be controlled based on the change of the moving speed of the optical elements.

In some embodiments, the control unit may be further configured to control the emission frequency and/or emission power of the light pulse sequence at the first time to be less than the emission frequency and/or emission power of the light pulse sequence at the second time when the first moving speed of the optical elements at the first time is less than the second moving speed of the optical elements at the second time.

In some embodiments, the control unit may be further configured to control the emission frequency and/or emission power of the light pulse sequence to change stepwise with the moving speed of the optical elements.

In some embodiments, the control unit may be further configured to control the light pulse generating unit to stop emitting light pulse sequence when the moving speed of the optical elements is lower than a predetermined minimum speed.

In some embodiments, the light emission device may further include a prompting unit configured to send a prompt signal when the moving speed of the optical elements is lower than a predetermined minimum rotation speed.

In some embodiments, the light emission device may further include a receiving unit configured to receive the light pulse signal reflected by the object.

An embodiment of the present disclosure provides a laser scanning system, which may include the light emission device described in the foregoing embodiments.

The light emission method and device, and the scanning system provided by the various embodiments of the present disclosure can be applied to a distance measuring device. The distance measuring device may be an electronic device such as a lidar and a laser distance measuring device. In some embodiments, the distance measuring device can be used to sense external environmental information, such as distance information, orientation information, reflection intensity information, speed information, etc. of targets in the environment. In some embodiments, the distance measuring device can detect the distance from a detection object to the distance measuring device by measuring the time of light propagation between the distance measuring device and the detection object, that is, the time-of-flight (TOF). Alternative, the distance measuring device can also detect the distance from the detection object to the distance measuring device through other methods, such as the distance measuring method based on phase shift measurement, or the distance measuring method based on frequency shift measurement, which is not limited in the embodiments of the present disclosure.

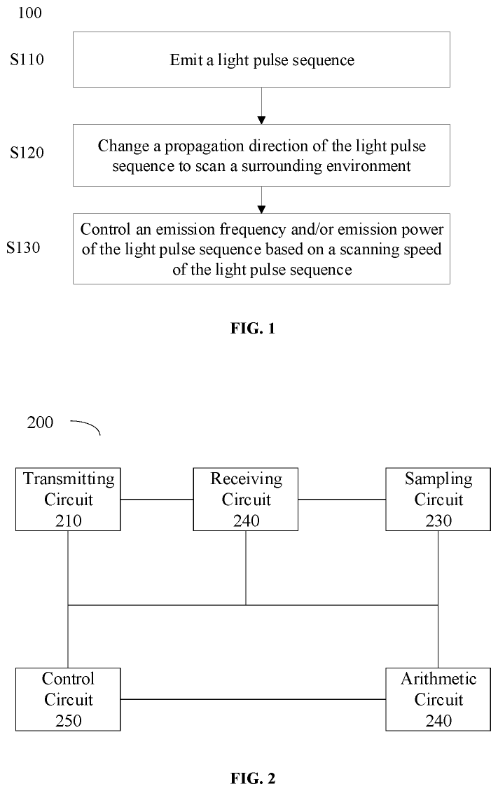

For ease of understanding, the working process of distance measurement will be described below in conjunction with a distance measuring device 200 shown in FIG. 2.

As shown in FIG. 2, the distance measuring device 200 includes a transmitting circuit 210, a receiving circuit 220, a sampling circuit 230, and an arithmetic circuit 240.

The transmitting circuit 210 may emit a light pulse sequence (e.g., a laser pulse sequence). The receiving circuit 220 can receive the light pulse sequence reflected by the object to be detected, and perform photoelectric conversion on the light pulse sequence to obtain an electrical signal, and then the electrical signal can be processed and output to the sampling circuit 230. The sampling circuit 230 can sample the electrical signal to obtain a sampling result. The arithmetic circuit 240 may determine the distance between the distance measuring device 200 and the object to be detected based on the sampling result of the sampling circuit 230.

In some embodiments, the distance measuring device 200 may further include a control circuit 250. The control circuit 250 can control other circuit, for example, control the working time of each circuit and/or set parameters for each circuit, etc.

It should be understood that although the distance measuring device shown in FIG. 2 includes a transmitting circuit, a receiving circuit, a sampling circuit, and an arithmetic circuit to emit a light beam for detection, however, the embodiments of the present disclosure are not limited thereto. The number of any one of the transmitting circuit, the receiving circuit, the sampling circuit, and the arithmetic circuit may also be at least two, which can be used to emit at least two light beams in the same direction or different directions. In some embodiments, the at least two light beams may be emitted at the same time or at different times. In one example, the light emitting chips in the at least two emitting circuits may be packaged in the same module. For example, each transmitting circuit may include a laser transmitting chip, and the dies in the laser transmitting chips in the at least two transmitting circuits may be packaged together and housed in the same packaging space.

In some implementations, in addition to the circuit shown in FIG. 2, the light detection device 200 may further include a scanning module 260, which can be used to change the propagation direction of at least one laser pulse sequence emitted by the transmitting circuit and emit it.

In some embodiments, a module including the transmitting circuit 210, the receiving circuit 220, the sampling circuit 230, and the arithmetic circuit 240, or a module including the transmitting circuit 210, receiving circuit 220, sampling circuit 230, arithmetic circuit 240, and control circuit 250 may be referred to as a distance measuring module. The distance measuring module 250 may be independent of other modules, such as the scanning module 260.

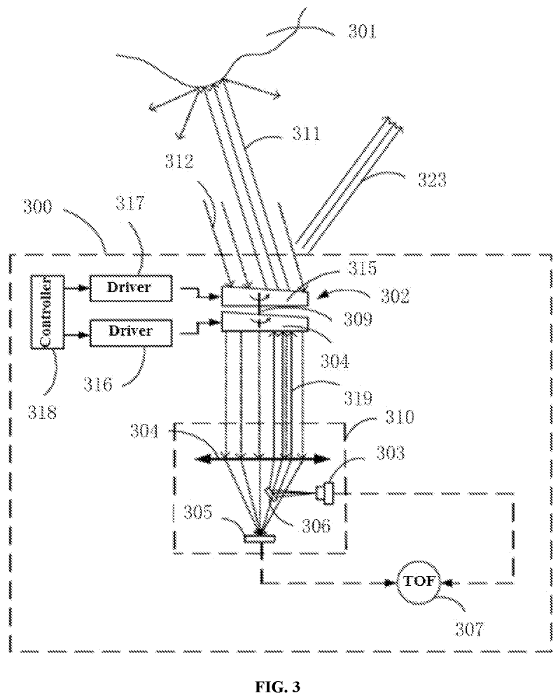

A coaxial light path may be used in the distance measuring device, that is, the light beam emitted by the distance measuring device and the reflected light beam can share at least a part of the light path in the distance measuring device. For example, after at least one laser pulse sequence emitted by the transmitting circuit changes its propagation direction through the scanning module and exits, the laser pulse sequence reflected by the object to be detected may pass through the scanning module and enter the receiving circuit. Alternatively, the distance measuring device may also adopt an off-axis light path, that is, the light beam emitted by the distance measuring device and the reflected light beam may be respectively transmitted along different light paths in the distance measuring device. FIG. 3 is a schematic diagram of a light detection device using a coaxial light path according to an embodiment of the present disclosure.

A distance measuring device 300 includes a distance measuring module 310. The distance measuring module 310 includes a transmitter 303 (including the transmitting circuit described above), a collimating element 304, a detector 305 (which may include the receiving circuit, sampling circuit, and arithmetic circuit described above), and a light path changing element 306. The distance measuring module 310 may be used to transmit the light beam, received the returned light, and convert the returned light into an electrical signal. In some embodiments, the transmitter 303 may be used to emit a light pulse sequence. In one embodiment, the transmitter 303 may emit laser pulses. In some embodiments, the laser beam emitted by the transmitter 303 may be a narrow-bandwidth light beam with a wavelength outside the visible light range. The collimating element 304 may be disposed on an exit light path of the transmitter and used to collimate the light beam emitted from the transmitter 303 and collimate the light beam emitted from the transmitter 303 into parallel light and output to the scanning module. The collimating element may also be used to condense at least a part of the returned light reflected by the object to be detected. The collimating element 304 may be a collimating lens or other elements capable of collimating light beams.

In the embodiment shown in FIG. 3, by using the light path changing element 306 to combine the transmitting light path and the receiving light path in the distance measuring device before the collimating element 304, the transmitting light path and the receiving light path can share the same collimating element, making the light path more compact. In some other implementations, the transmitter 303 and the detector 305 may also use their respective collimating elements, and the light path changing element 306 may be disposed on the light path behind the collimating element.

In the embodiment shown in FIG. 3, since the beam aperture of the light beam emitted by the transmitter 303 is relatively small, and the beam aperture of the returned light received by the distance measuring device is relatively large, the light path changing element may use a small-area mirror to combine the emitting light path and the receiving light path. In some other implementations, the light path changing element may also adopt a reflector with a through hole, where the through hole may be used to transmit the emitted light of the transmitter 303, and the reflector may be used to reflect the returned light to the detector 305. In this way, it is possible to reduce the blocking of the returned light by the support of the small reflector when the small reflector is used.

In the embodiment shown in FIG. 3, the light path changing element may deviate from the optical axis of the collimating element 304. In some other implementations, the light path changing element may also be positioned on the optical axis of the collimating element 304.

The distance measuring device 300 may further include a scanning module 302. The scanning module 302 may be disposed on the exit light path of the distance measuring module 310. The scanning module 302 may be used to change the transmission direction of a collimated light beam 319 emitted by the collimating element 304, and project the returned light to the collimating element 304. The returned light may be collected on the detector 305 via the collimating element 304.

In one embodiment, the scanning module 302 may include at least one optical element for changing the propagation path of the light beam, where the optical element may change the propagation path of the light beam by reflecting, refracting, or diffracting the light beam. For example, the scanning module 302 may include a lens, a mirror, a prism, a galvanometer, a grating, a liquid crystal, an optical phased array, or any combination of the foregoing optical elements. In one example, at least part of the optical element may be movable. For example, the at least part of the optical element may be driven by a driving module, and the movable optical element can reflect, refract, or diffract the light beam to different directions at different times. In some embodiments, a plurality of optical elements of the scanning module 302 may rotate around a common axis 309, and each rotating or vibrating optical element may be used to continuously change the propagation direction of the incident light beam. In one embodiment, the plurality of optical elements of the scanning module 302 may rotate at different rotation speeds or vibrate at different speeds. In another embodiment, the plurality of optical elements of the scanning module 302 may rotate at substantially the same rotation speed. In some embodiments, the plurality of optical elements of the scanning module 302 may also be rotated around different axes. In some embodiments, the plurality of optical elements of the scanning module 302 may also be rotated in the same direction or in different directions, or vibrate in the same direction or different directions, which is not limited herein.

In one embodiment, the scanning module 302 may include a first optical element 314 and a driver 316 connected to the first optical element 314. The driver 316 may be used to drive the first optical element 314 to rotate around the rotation axis 309, such that the first optical element 314 can change the direction of the collimated light beam 319. The first optical element 314 may project the collimated light beam 319 to different directions. In one embodiment, an angle between the direction of the collimated light beam 319 changed by the first optical element and the rotation axis 309 may change with the rotation of the first optical element 314. In one embodiment, the first optical element 314 may include a pair of opposite non-parallel surfaces, and the collimated light beam 319 may pass through the pair of surfaces. In one embodiment, the first optical element 314 may include a prism whose thickness may vary in at least one radial direction. In one embodiment, the first optical element 314 may include a wedge-angle prism to collimate the beam 319 for refracting.

In one embodiment, the scanning module 302 may further include a second optical element 315. The second optical element 315 may rotate around the rotation axis 309, and the rotation speed of the second optical element 315 may be different from the rotation speed of the first optical element 314. The second optical element 315 may be used to change the direction of the light beam projected by the first optical element 314. In one embodiment, the second optical element 315 may be connected to another driver 317, and the driver 317 may drive the second optical element 315 to rotate. The first optical element 314 and the second optical element 315 may be driven by the same or different drivers, such that the first optical element 314 and the second optical element 315 may have different rotation speeds and/or steering directions, such that the collimated light beam 319 may be projected to different directions in the external space to scan a larger spatial range. In one embodiment, a controller 318 may control the driver 316 and driver 317 to drive the first optical element 314 and the second optical element 315, respectively. The rotation speeds of the first optical element 314 and the second optical element 315 may be determined based on the area and pattern expected to be scanned in actual applications. The drivers 316 and 317 may include motors or other driving devices.

In some embodiments, the second optical element 315 may include a pair of opposite non-parallel surfaces, and a light beam may pass through the pair of surface. In one embodiment, the second optical element 315 may include a prism whose thickness may vary in at least one radial direction. In one embodiment, the second optical element 315 may include a wedge-prism.

In one embodiment, the scanning module 302 may further include a third optical element (not shown in the drawings) and a driver for driving the third optical element to move. In some embodiments, the third optical element may include a pair of opposite non-parallel surfaces, and a light beam may pass through the pair of surface. In one embodiment, the second optical element may include a prism whose thickness may vary in at least one radial direction. In one embodiment, the second optical element may include a wedge-prism. At least two of the first, second, and third optical elements may rotate at different rotation speeds and/or rotation directions.

The rotation of each optical element in the scanning module 302 may project light to different directions, such as directions of light 311 and 313, such that the space around the distance measuring device 300 can be scanned. When the light 311 projected by the scanning module 302 hits an object to be detected 301, a part of the light may be reflected by the object to be detected 301 to the distance measuring device 300 in a direction opposite to the projected light 311. The returned light 312 reflected by the object to be detected 301 may incident on the collimating element 304 after passing through the scanning module 302.

The detector 305 and the transmitter 303 may be placed on the same side of the collimating element 304, and the detector 305 may be used to convert at least part of the returned light passing through the collimating element 304 into electrical signals.

In one embodiment, each optical element may be coated with an anti-reflection coating. In some embodiments, the thickness of the anti-reflection coating may be equal to or close to the wavelength of the light beam emitted by the transmitter 303, which can increase the intensity of the transmitted light beam.

In one embodiment, a filtering layer may be plated on the surface of an element positioned on the light beam propagation path in the distance measuring device, or a filter may be disposed on the light beam propagation path for transmitting at least the wavelength band of the light beam emitted by the transmitter, and reflect other wavelength bands to reduce the noise caused by ambient light to the receiver.

In some embodiments, the transmitter 303 may include a laser diode, and nanosecond laser pulses may be emitted through the laser diode. Further, the laser pulse receiving time may be determined, for example, by detecting the rising edge time and/or falling edge time of the electrical signal pulse to determine the laser pulse receiving time. In this way, the distance measuring device 300 may calculate the TOF using the pulse receiving time information and the laser pulse sending time information, thereby determining the distance from the object to be detected 301 to the distance measuring device 300.

The distance and orientation detected by the distance measuring device 300 may be used for remote sensing, obstacle avoidance, surveying and mapping, navigation, and the like. In one embodiment, the distance measuring device of the embodiments of the present disclosure can be applied to a mobile platform, and the distance measuring device can be mounted on the platform body of the mobile platform. The mobile platform including the distance measuring device can measure the external environment, such as measuring the distance between the mobile platform and obstacles for obstacle avoidance and other purposes, and for two-dimensional or three-dimensional mapping of the external environment. In some embodiments, the mobile platform may include at least one of an unmanned aerial vehicle, a car, a remote control car, a robot, and a camera. When the distance measuring device is applied to an unmanned aerial vehicle, the platform body may be the body of the unmanned aerial vehicle. When the distance measuring device is applied to a car, the platform body may be the body of the car. The car may be a self-driving vehicle or a semi-self-driving vehicle, which is not limited here. When the distance measuring device is applied to a remote control car, the platform body may be the body of the remote control car. When the distance measuring device is applied to a robot, the platform body may be the robot. When the distance measuring device is applied to a camera, the platform body may be the camera itself.

The light emission method and device, and the scanning system provided in the previous embodiments of the present disclosure can change the emission frequency and/or emission power of the light pulse based on the scanning speed. In this way, a higher scanning point cloud density can be obtained while meeting the laser safety of the human eye.

The technical terms used in the embodiments of the present disclosure are merely used to describe some embodiments and are not intended to limit the present disclosure. As used herein, the singular forms “a”, “an”, and “the” are intended to include the plural forms as well, unless the context clearly indicates other cases. Further, the use of “including” and/or “comprising” when used in the specification means that the features, integers, steps, operations, elements and/or components are present but do not preclude the presence or addition of one or more other features, integers, steps, operations, elements, and/or components.

The corresponding structures, materials, acts, and equivalents of all means or steps, and function elements, if any, in the appended claims are intended to include any structure, material, or act for performing the function in combination with other explicitly claimed elements. The description of the present disclosure has been presented for purposes of illustration and description, but is not intended to be exhaustive or limited to the disclosure in the form disclosed. Many modifications and variations will be apparent to those skilled in the art without departing from the scope and spirit of the disclosure. The embodiments described in the present disclosure can better understand the principle and practical application of the present disclosure and make those skilled in the art understand the present disclosure.

The flowchart described in the present disclosure is merely an example and various modifications may be made to this illustration or the steps in the present disclosure without departing from the spirit of the present disclosure. For example, these steps can be executed in different orders, or some steps can be added, deleted, or modified. Those of ordinary skill in the art can understand that all or part of the procedures for implementing the foregoing embodiments and equivalent variations made according to the claims of the present disclosure still fall in the scope of the present disclosure.

What is claimed is:

1. A light emission method, comprising:
emitting a light pulse sequence;
changing a propagation direction of the light pulse sequence to scan a surrounding environment; and
controlling an emission frequency and/or emission power of the light pulse sequence based on a scanning speed of the light pulse sequence.

2. The method of claim 1, further comprising:
detecting the scanning speed of the light pulse sequence; and
changing the emission frequency and/or emission power of the light pulse sequence based on a change of the scanning speed of the light pulse sequence when the scanning speed of the light pulse sequence is within a predetermined range.

3. The method of claim 2, wherein changing the emission frequency and/or emission power of the light pulse sequence includes:
controlling the emission frequency and/or emission power of the light pulse sequence at a first time to be less than the emission frequency and/or emission power of the light pulse sequence at a second time, the scanning speed of the light pulse sequence at the first time being lower than the scanning speed of the light pulse sequence at the second time.

4. The method of claim 3, wherein changing the emission frequency and/or emission power of the light pulse sequence includes:
increasing the emission frequency and/or emission power of the light pulse sequence when the scanning speed of the light pulse sequence increases; and/or,
reducing the emission frequency and/or emission power of the light pulse sequence when the scanning speed of the light pulse sequence decreases.

5. The method of claim 3, wherein controlling the emission frequency and/or emission power of the light pulse sequence includes:
controlling the emission frequency and/or emission power of the light pulse sequence to a first emission frequency and/or first emission power when the scanning speed of the light pulse sequence is within a first range; and
controlling the emission frequency and/or emission power of the light pulse sequence to a second emission frequency and/or second emission power when the scanning speed of the light pulse sequence is within a second range,
values in the first range being greater than values in the second range, and the first emission frequency and/or first emission power being greater than the second emission frequency and/or second emission power.

6. The method of claim 2, further comprising:
stopping emitting the light pulse sequence when the scanning speed of the light pulse sequence is lower than a predetermined minimum rotation speed.

7. The method of claim 1, wherein changing the propagation direction of the light pulse sequence includes:
changing the propagation direction of the light pulse sequence through one or more moving optical elements.

8. The method of claim 1, wherein changing the propagation direction of the light pulse sequence includes:
changing the propagation direction of the light pulse sequence through one or more rotating light refraction elements, the one or more rotating light refraction elements including opposite, and non-parallel light-emitting surfaces and light-incident surfaces.

9. The method of claim 1, further comprising:
determining the scanning speed of the light pulse sequence based on a moving speed of the one or more moving optical elements.

10. The method of claim 2, further comprising:
prompting a user when the scanning speed of the light pulse sequence is lower than the predetermined minimum rotation speed.

11. The method of claim 1, further comprising:
receiving a light pulse signal reflected by an object; and
determining a position of the object based on the received light pulse signal.

12. A light emission device comprising:
a light pulse generating unit configured to emit a light pulse sequence;
one or more optical elements configured to change a propagation direction of the light pulse sequence to scan a surrounding environment; and
a control unit configured to control an emission frequency and/or emission power of the light pulse sequence based on a scanning speed of the light pulse sequence.

13. The device of claim 12, further comprising:
a detection unit configured to detect the scanning speed of the light pulse sequence, wherein the control unit is further configured to determine whether the scanning speed of the light pulse sequence is within a predetermined range, and calculate a change in the scanning speed of the light pulse sequence and control the emission frequency and/or emission power of the light pulse sequence based on the change of the scanning speed of the light pulse sequence if the scanning speed of the light pulse sequence is within the predetermined range.

14. The device of claim 12, wherein the control unit is further configured to:
control the emission frequency and/or emission power of the light pulse sequence at a first time to be less than the emission frequency and/or emission power of the light pulse sequence at a second time, the scanning speed of the light pulse sequence at the first time being lower than the scanning speed of the light pulse sequence at the second time.

15. The device of claim 12, wherein the control unit is further configured to:
increase the emission frequency and/or emission power of the light pulse sequence when the scanning speed of the light pulse sequence increases; and/or,
reduce the emission frequency and/or emission power of the light pulse sequence when the scanning speed of the light pulse sequence decreases.

16. The device of claim 12, wherein the control unit is further configured to:
control the emission frequency and/or emission power of the light pulse sequence to a first emission frequency and/or first emission power when the scanning speed of the light pulse sequence is within a first range; and
control the emission frequency and/or emission power of the light pulse sequence to a second emission frequency and/or second emission power when the scanning speed of the light pulse sequence is within a second range,
values in the first range being greater than values in the second range, and the first emission frequency and/or first emission power being greater than the second emission frequency and/or second emission power.

17. The device of claim 12, wherein the control unit is further configured to:
stop emitting the light pulse sequence when the scanning speed of the light pulse sequence is lower than a predetermined minimum rotation speed.

18. The device of claim 12, wherein changing the propagation direction of the light pulse sequence includes:
changing the propagation direction of the light pulse sequence through one or more moving optical elements.

19. The device of claim 12, wherein changing the propagation direction of the light pulse sequence includes:
changing the propagation direction of the light pulse sequence through one or more rotating refraction elements, the one or more rotating refraction elements including opposite, and non-parallel light-emitting surfaces and light-incident surfaces.

20. A distance measuring device comprising:
a light emission device configured to emit light pulse sequences in sequence, the light emission device including
a light pulse generating unit configured to emit the light pulse sequences;
one or more optical elements configured to change a propagation direction of the light pulse sequence to scan a surrounding environment; and
a control unit configured to control an emission frequency and/or emission power of the light pulse sequence based on a scanning speed of the light pulse sequence;
a receiving circuit configured to receive part of a light pulse signal reflected by an object from the light pulse sequence emitted by the light emission device, and convert the received light pulse signal into an electrical signal;
a sampling circuit configured to sample the electrical signal from the receiving circuit to obtain a sampling result; and
an arithmetic circuit configured to calculate a distance between the object and the distance measuring device based on the sampling result.
